(19) United States
(12) Patent Application Publication
(10) Pub. No.: US 2021/0178349 A1
(43) Pub. Date: Jun. 17, 2021

(54) MIXING DEVICES AND ASSEMBLIES

(71) Applicant: John Warner, Billerica, MA (US)

(72) Inventor: John Warner, Billerica, MA (US)

(21) Appl. No.: 16/715,421

(22) Filed: Dec. 16, 2019

(51) Int. Cl. B01F 13/00; B44D 3/10

(52) U.S. Cl. CPC B01F 13/0028; B01F 2215/005; B44D 3/105; B01F 13/0033

(57) ABSTRACT

The present disclosure relates to paint mixing devices, and more specifically to a paint mixing device comprising a shaft portion and a clamp portion. The clamp portion of the disclosed mixing devices is capable of receiving a disposable paint stirrer. The shaft of the disclosed devices is sized to be received by commercially available power drills and electric screwdrivers. The disclosed device advantageously facilitate the mixing of paint by a disposable paint stirrer at revolutions per minute not achievable by hand-mixing.

### FIELD OF DISCLOSURE

The present disclosure relates to devices and assemblies for paint, and more specifically, to devices, assemblies, and methods for the mixing of paints prior to their application on a surface.

### SUMMARY OF DISCLOSURE

The present disclosure is directed to devices, assemblies, and methods that facilitate the mixing of paint. The disclosed device, assemblies, and methods may advantageously use a disposable mixing tool.

In accordance with an aspect of the disclosure, a paint mixing device is disclosed comprising a shaft having a first end and a second end and a clamp affixed to the second of the shaft, wherein the clamp is configured to receive a mixing tool. In accordance with embodiments, the first end of the shaft may be sixed to be received by a power drill or electric screwdriver.

In some embodiments, the mixing tool is a paint stirrer and may further be disposable. In accordance with embodiments, the clamp and shaft may be a single body.

In accordance with embodiments, the clamp may comprise a receiving slot configured to receive a paint stirrer and a fastener that is configured to pass through a hole in the clamp and into the receiving slot to secure the paint stirrer. In other embodiments, the clamp may comprise a bottom portion and a top portion each having a first end and second end, wherein the bottom portion and top portion are connected to one another by a spring such that the top portion can be rotated about the axis of the spring. The spring may urge the first end of the top portion into contact with the first end of the bottom portion. In some embodiments, the clamp may further comprise a set of teeth on the bottom portion and a set of teeth on the top portion. The top teeth and bottom teeth may mate with one another when the top portion is urged into contact with the bottom portion. The top teeth may be configured to disengage with the bottom teeth when a downward force is exerted onto the second end of the top portion. In accordance with embodiments, a paint stirrer may be inserted in between the bottom teeth and the top teeth, and the teeth may aid in securing the stirrer in the clamp.

In accordance with another aspect of the disclosure, a paint stirring kit is disclosed, the kit comprising a paint stirring device having a shaft that has a first end and a second end and a clamp affixed the second end of the shaft, wherein the clamp is configured to receive a paint stirrer and includes a plurality of disposable paint stirrers. The clamp of the device included in the kit may have a set of bottom and top that mate with one another. The kit may further include at least one container having a bottom and at least one side wall having a bottom end connected to the bottom and a top end, and a lid that forms an air-tight seal with the top end of the at least one side wall. The kit may further include an electric screwdriver.

In accordance with another aspect of the discourse, a method of mixing paint is disclosed. The method comprises securing a paint stirrer in the clamp of the devices disclosed, securing the shaft of the devices disclosed in an electric screwdriver, inserting the secured paint stirrer into a quantity of paint to be mixed, and operating the electric screwdriver to cause the shaft to rotate at a speed of between about 200 RPMs to 3000 RPMs.

### BACKGROUND

Painting, be it exterior or interior applications, is considered one of the top home-improvement projects. In addition to the residential use of paint, paints are also used commercially in a wide range of industries. The components of paint dictate its performance characteristics, from how it is applied, to how it wears, to how clean-up must be performed after a project has been completed.

Paints are manufactured according to their end use. There are typically four main components in a paint; pigment, binder, liquid, and additives. These components are generally present in paint whether the paint be for a residential or industrial application. These components are carefully selected by paint manufacturers and are included in the paint in very specific ratios. A paint's pigment plays the primary role in determining the color and appearance of the paint. Pigment may be prime pigment, pigment responsible for color, whiteness, and hiding undesirable surface flaws, or extender pigments, pigments that are designed add bulk to the paint that increase its durability. The paint binder is responsible for providing adhesion of the paint to the application surface and binding the pigment to the surface. Binder also can include properties which make the final coating of paint tough and durable. The amount of binder in a given paint impacts the finish of the paint, where less binder leads to a glossy finish and more binder results in a more matte finish. Binders are selected based on the paint, and more specifically, whether the paint is oil-based or latex-based.

Oil-based paints require a binder that has similar properties to the paint, such that the binder oxidizes and dries when exposed to air and hardens along with the rest of the paint. In oil-based paints, the liquid binder evaporates, and the binder reacts with the air to harden into place with the pigment.

In latex-based paints, the binder that is used is plastic-like and creates a film in the paint that resembles latex rubber, which gives these types of paints their name. Latex-based paints are, however, a bit of a misnomer in that they do not actually have latex in them. Almost all water-based paints, however, have a latex-based binder. When the paint is applied, the water evaporates from the paint, leaving behind a film of pigment and binder which bind together into a coating. The binder and pigment fuse by a chemical process referred to as coalescence. Common types of latex-based binders include acrylic and vinyl acrylic.

The liquid in the paint is responsible for transporting the binder and pigment to the surface to be painted. The liquid in the paint depends upon the other components in the paint. Oil-based paints, for example, can use turpentine. Latex-based paints tend to use water as their liquid.

Paints often contain additives that enhance the paint properties. Thickeners may be used to facilitate easier application, surfactants may be used to help disperse pigments within the paint, and co-solvents can be used to facilitate binder film formation, to enhance the longevity of the liquid paint, and to lengthen the amount of type the paint can be exposed to air before beginning to set.

While painting itself is generally an easy task, the components of the paint being applied must be well-mixed in order for the paint to perform as intended. When paint is purchased, for example, at a hardware store, the paint is mixed by a machine that ensures that all components, including the pigment, are well-mixed. Over time, however, the solid components in the paint separate from the liquid components. In order for the paint to be useable, the solids must be stirred smoothly back into the liquid components.

Paint, even if in a sealed and unopened can that has never been exposed to air, will, if left for prolonged periods, separate. The paint is not well-mixed before application, the ratio of components in the paint applied to a surface may not be ideal. For example, solid pigment particles may stay settled on the bottom of the paint and the resultant paint coating will be off in color. Likewise, if the ratio of liquid to solid is too high, the paint may apply too thinly, be difficult to apply, and may not dry with the desired surface properties.

Unfortunately, when a separated can is opened by a user, it is often difficult for the user to adequately mix the components by hand. The process can be taxing and labor intensive. Using a traditional disposable wooden paint stirrer by hand is often insufficient to adequately mix separated paint for use. As a result, separated paint is often discarded. Moreover, it is important that whatever tool is used to mix the paint not contain any materials or pigments that could contaminate the paint and negatively impact its performance. Thus, typically, mixing must be done with a clean tool. Non-disposable mixing tools must therefore be thoroughly cleaned after to each use. Cleaning a mixing tool is often also laborious and, depending on the paint mixed, may require organic solvents. Cleaning paint off any surface and cleaning up after a project in general is often a loathed task. There thus exists a need for an easy and economical way for an individual to mix separated paint that is not labor intensive and ensures a well-mixed end result that also ameliorates or avoids the necessity of cleaning the mixing tool used.

### DETAILED DESCRIPTION OF THE FIGURES

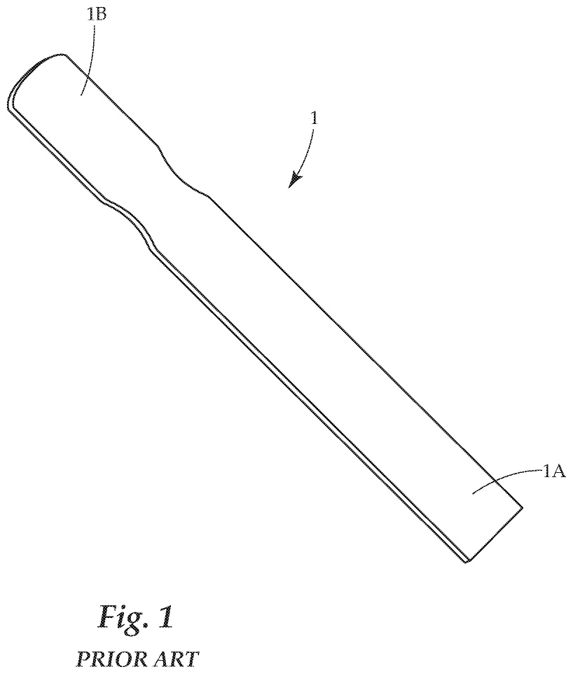

FIG. 1 shows a paint stirrer known in the art;

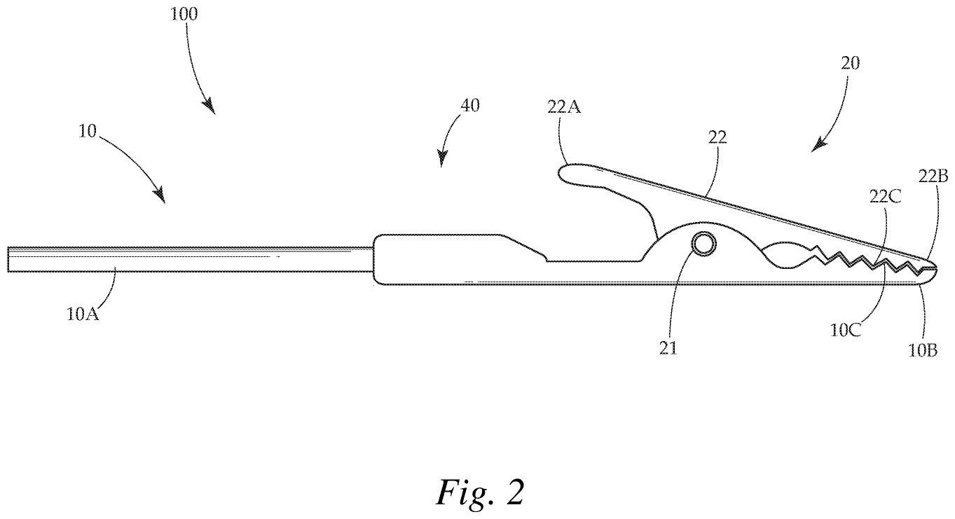

FIG. 2 shows a device in accordance with aspects and embodiments of the present disclosure;

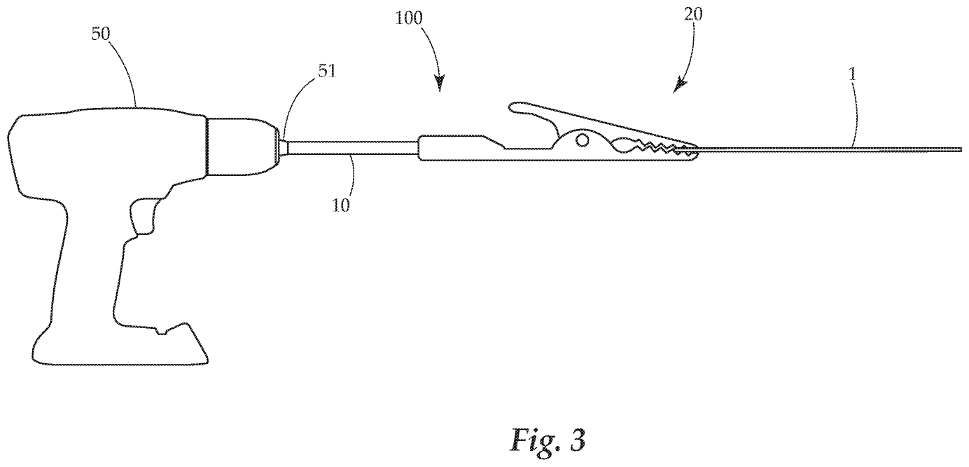

FIG. 3 shows an assembly including a device in accordance with aspects and embodiments of the present disclosure;

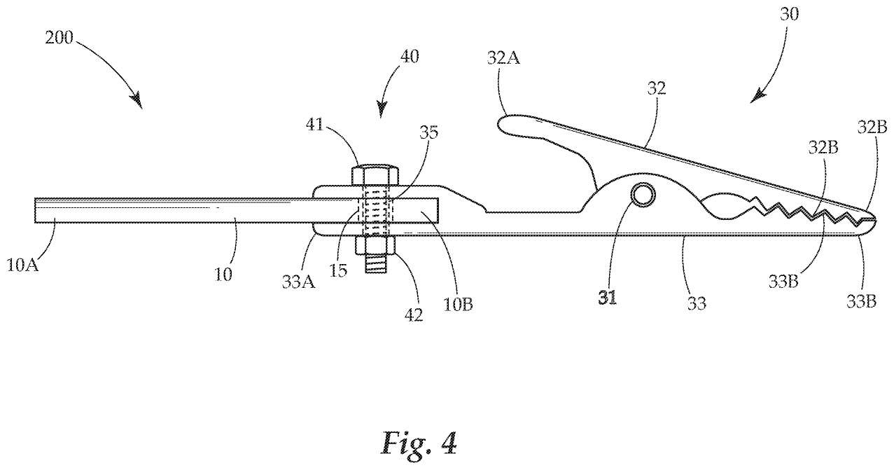

FIG. 4 shows a device in accordance with aspects and embodiments of the present disclosure;

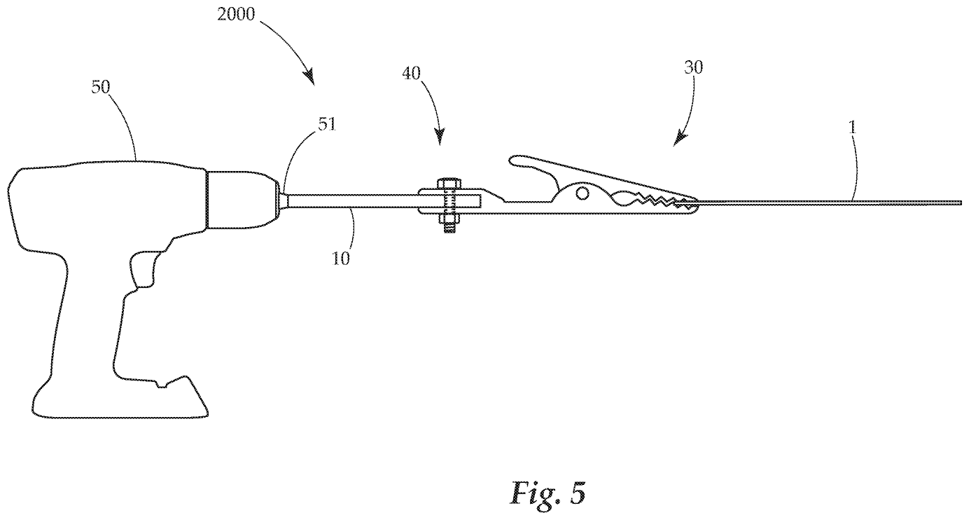

FIG. 5 shows an assembly including a device in accordance with aspects and embodiments of the present disclosure;

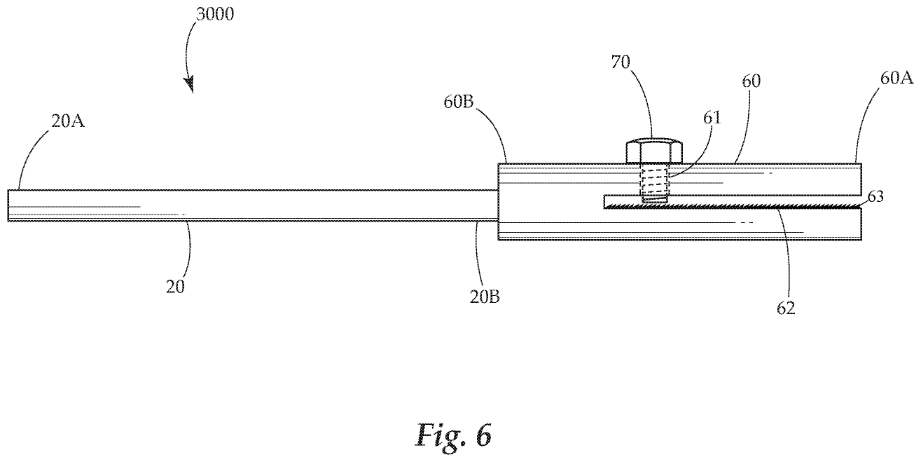

FIG. 6 shows a device in accordance with aspects and embodiments of the present disclosure; and

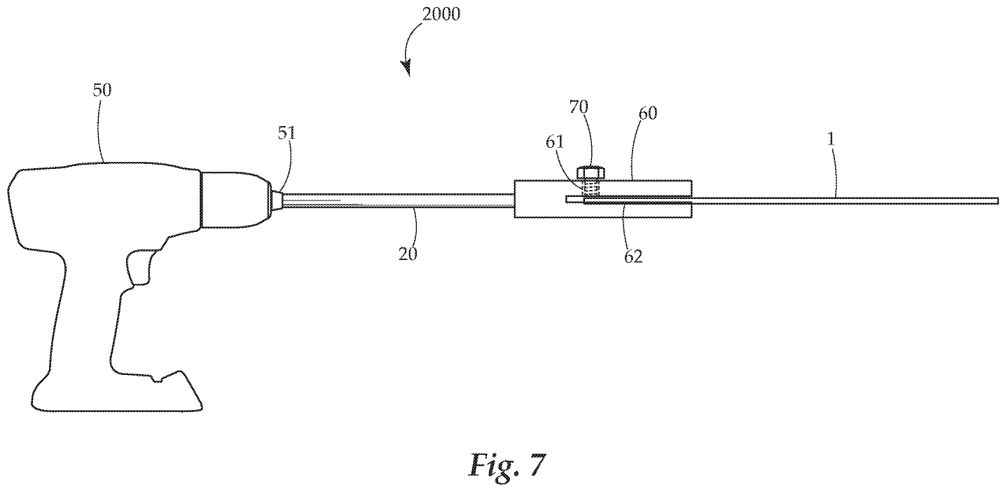

FIG. 7 shows an assembly including a device in accordance with aspects and embodiments of the present disclosure.

### DETAILED DESCRIPTION

The present disclosure is directed to tools, devices, assemblies, and methods that facilitate the mixing of paint. The tools, devices, assemblies, and methods disclosed may be used on any paint and in any container, provided the container has an opening sufficient to accommodate the tools, devices, and assemblies disclosed. The paint to be mixed by the tools, devices and assemblies disclosed in accordance with the disclosed methods may be an oil-based or latex-based/water-based paint. The paint may be of any chemical makeup for any application. For example, the paint may be of any color and have any pigment types, may include any binder, may be of any liquid, and have any additives. The paint may be intended to be used in any residential, commercial, or industrial application, for any purpose, and on any surface. Paint mixed by the tools, devices, and assemblies disclosed and in accordance with the disclosed methods may be applied to a surface by brush, roller, sprayer, or other methods known in the art.

Paint may be mixed for any reason, including but not limited to exhibiting visible signs of separation. For example, a quantity of paint showing visible signs of separation by, for example, having visible layers of unmixed material, may be mixed tools, devices, assemblies disclosed in accordance with the disclosed methods, to homogenize the mixture prior to use. Mixing with the disclosed tools, devices, and assemblies in accordance with the disclosed methods may mix a paint that, prior to mixing, is unsuitable for application to a surface. After mixing with the disclosed tools, devices, and assemblies in accordance with the disclosed methods, the paint may be rendered suitable for application to a surface.

For example, devices and assemblies may be used in accordance with the disclosed methods may be used to mix solids that have separated out from the liquid of a quantity of paint back into the liquid to give a homogenous paint suitable for its intended use. Paint may be mixed prior to use, despite appearing to the eye to be homogenous. The disclosed devices and assemblies may also be used in accordance with the disclosed methods to mix layers of separated liquid in a quantity of paint, and the quantity of paint need not have a layer of solids visible.

Moreover, the disclosed devices and assemblies may be used in accordance with the disclosed methods to mix a paint that appears homogenous. For example, the disclosed devices and assemblies may be used in accordance with the disclosed methods to ensure the pigment in a quantity of paint is uniformly distributed throughout the paint, or the paint may be mixed with the disclosed devices and assemblies in accordance with the disclosed methods simply to ensure that all components in the paint are mixed to an ideal state to ensure the best application and end result.

The disclosed devices and assemblies used in accordance with the disclosed methods may advantageously reduce of avoid contamination that could otherwise result from the mixing of a paint with a tool that has been used to mix another paint. For example, the disclosed devices and assemblies may include a disposable feature that allows for several different paints to be mixed with a disposable component. The disposable components used may be inexpensive and thus be an economical way to mix several different paints while also avoiding cross-contamination. The use of a disposable mixing component also avoids the need to clean the tool after use, thus reducing the overall cleanup required for a given paint project.

Paint is typically mixed with paint stirrers. Paint stirrers are often provided free of charge with the purchase of a quantity of paint. They are an inexpensive item and are often labeled with a logo and used as a marketing item by, for example, listing a store, its location, and contact information for where paint can be purchased. Paint stirrers are also made available for sale and are often sold in stores where paint can be purchased. Because of their inexpensiveness, after a paint stirrer is used, it is readily discarded. Users generally do not bother to clean the stirrer and save it for future mixing.

Referring to FIG. 1, paint stirrer 1 generally takes the form of a long, narrow, and substantially rectangular paddle. Paint stirrer 1 has a find end 1A and a second end 1B. End 1B may have a shape different than end 1A. For example, end 1A may terminate in a straight bottom with angular corners whereas end 1B may have a slightly rounded top. Stirrer 1 may have further features that aid in mixing and/or designate the which end is best for mixing, including for example, contoured section in between end 1B and end 1A.

Paint stirrers of the type shown in FIG. 1 are generally made of inexpensive wood. The stirrer may however be made of any material. Paint stirrer 1 referenced herein may be made of wood, plastic, metal, or any other suitable material known in the art.

A user seeking to stir a quantity of paint stored in a container generally holds end 1A with their hand and inserts end 1B into the quantity of paint in the container. The user than manually moves stirrer 1 in a circle to stir the paint. Depending on the quantity and thickness of the paint being stirred, mixing can be surprisingly taxing as a result of the resistance the paint places on the stirrer. The present disclosure advantageously uses readily available powered tools to cause a paint stirrer 1 to mix a quantity of paint.

The present disclosure advantageously provides a device able to receive paint stirrer 1. The disclosed devices have a shaft end and a paint stirrer receiving end. The device can be used in an electric screwdriver or power drill such that the paint stirrer is rotated by the drill. An end of the device is received by the chuck of the drill and the paint stirrer is placed in the paint such that it is rotated about a central axis by the drill motor. The rotations of the paint stirrer cause the paint to mix.

The devices disclosed can be used with any unit capable of receiving the shaft of the device and turning the shaft of the device at a suitable speed. The devices of the present disclosure are preferably received by a unit capable of rotating the shaft of the device at a speed of between 200 revolutions per minute and 3000 revolutions per minute (RPMs). The use of a device able to turn the shaft at between about 200 RPMs to 3000 RPMs advantageously provides for the mixing of paint at RPMs not achievable by hand-mixing. The enhanced RPMs achievable by the devices of the present disclosure perform mixing operations better than achievable by hand mixing and are thereby able to mix separated paint that could not be otherwise be adequately mixed. Moreover, the disclosed devices may use a disposable mixing tool, such as paint stirrer 1, that is traditionally used for hand-mixing. The disclosed devices are thus able to achieve better mixing while making use of a disposable mixing tool.

Referring to FIGS. 2-3, in a first embodiment, device 100 includes a shaft 10 having a first end 10A and second end 10B. Device 100 has a shaft component 10 and a clip component 20. As shown in FIG. 2, shaft 10 has clip arm 22 connected to shaft 10 via spring 21. As shown in FIG. 2, shaft 10 may be a single and continuous component. Shaft 10 may be formed by injection molding or other known techniques in the art.

Referring to FIG. 2, shaft end 10B has thereon a set of clamping teeth 10C. Clip component 22 has first end 22A and second end 22B. Clip end 22B has a corresponding set of clamping teeth 22C. Clamping teeth 22C mate with clamping teeth 10C. Clamping teeth 22C of clip portion 20 may be disengaged form teeth 10C by exerting downward force on end 22A of clip portion 22, causing portion 22 to rotate about the axis at spring 21, thereby separating clamping teeth 22C from clamping teeth 10C.

Referring now to FIG. 3, assembly 1000 shows device 100 affixed to drill 50 and shows a mixing tool secured in clamp portion 20. The mixing tool shown in assembly 1000 is paint stirrer 1, however any mixing tool capable of being secured in clamp 30. Paint stirrer 1 is inserted into clip portion 20 of device 1000 at ends 10B and 22B. Paint stirrer 1 is held firmly in clip portion 20 by virtue of clamping teeth 22C and 10C. The force exerted by spring 21 urges clip portion 22 down onto stirrer 1. Clamping teeth 10C further aid in securing stirrer 1 in clip portion 20 of device 1000. End 10A of shaft 10 of device 100 is inserted into drill 50 at chuck 51 of drill 50. Chuck 51 of drill 50 expands and contracts to receive drill bits, as is known in the art, and is expanded to receive shaft 10 and then contracted to secure shaft 10 in chuck 51 of drill 50. Paint stirrer 1 of assembly 1000 can be inserted into a container having a quantity of paint. Drill 50 can then be powered to cause shaft 10, and thus paint stirrer 1, to rotate. The rotation of paint stirrer 1 causes the paint to mix. The clip may vary in size, though in particular embodiments, the clip may range in size between approximately ½″ to 2″ in width so as to be able to securely hold the mixing tool 1 during rotation and against the forces applied during the paint stirring. In other embodiments the clip may be approximately 4″ to 6″ long, and approximately ½″ to 3″ high.

Drill 50 can be any powered drill, cordless or corded, or electric screwdriver able to receive shaft 10 and cause shaft 10 to rotate when powered. Drill 50 preferably rotates shaft 10 at a speed of between about 200 RPMS and 3000 RPMs. Drill 50 may be purchased separately from device 100 or, in some embodiments, may be sold as part of a paint stirring kit including drill 50 and device 100. The paint stirring kit may further comprise paint stirrers, and the included paint stirrers may be disposable. Device 100 may be sold as an individual device or may be offered for sale with paint stirrers. In some embodiments, containers may be provided in which paint can be poured and then mixed and/or poured into and stored after mixing. Provided containers may take the shape of traditional paint cans or have a different shape and may, advantageously have a lid that forms an air-tight steal. The lid may be easier to open and close than the lid of a traditional paint can, which typically requires a flat-head screwdriver or similarly shaped tool to open the can and a hammer to secure the lid back onto the can. Storing of mixed paint in air-tight containers may prolong the shelf life of the paint and prevent, or reduce, the amount of mixing required to render the paint suitable for use.

FIGS. 4-5, another embodiment of a mixing device is shown. Device 200 includes a shaft 10 having a first end 10A and second end 10B. Device 200 further includes a clip 30 connected to shaft 10. Device 200 is shown as having a shaft piece and a clip piece. Clip 30 and shaft 10 can be connected by any methods known in the art. For example, clip 30 may be welded to shaft 10 or otherwise affixed to shaft 10 by methods known in the art without the use of a separate fastening system.

Referring to FIG. 4, clip 30 has a bottom portion 33 having a first end 33A that receives shaft 10 and a second end 33B. Shaft end 10B is received by end 33B of clip 33. Shaft 10 is connected to clip 33 by fastener 40. Fastener 40 may be any known fastener and is shown as bolt 41 and nut 42. Bolt 41 is passed through hole 35 in clip portion 33. Shaft 10 has a corresponding hole 15 that aligns with hole 35. Bolt 41 thus passes through shaft 10 such that the head of bolt 41 contacts the surface of clip portion 33 and the threaded portion of bolt 42 extends beyond clip portion 33. Nut 42 is threaded onto bolt 41 such that it contacts the surface of clip portion 33 opposite the surface where the head of bolt 41 contacts clip portion 33. Bolt 41 and nut 42 hold shaft 10 securely in clip 30.

As shown, nut 42 may be removed from bolt 41 and shaft 10 and clip 30 may be separated. In accordance with embodiments, fastener 40 may be welded or formed in some other known manner such that fastener 40 is not removable. In embodiments where fastener 30 is removable, separation of clip 30 from shaft 10 may provide advantageous features. For example, in embodiments where clip 30 and shaft 10 can be separated, either component of the device can be replaced should the other component fail. For example, if clip 30 becomes unusable for any reason, clip 30 could be removed from shaft 10 and replaced with another, working, clip 30.

Still referring to FIG. 4, clip 30 has top portion 32 connected to bottom portion 33 by spring 31. Top portion 33 has a first end 32A and a second end 32B. Bottom portion 33 of clip 30 has, proximate to end 33B, clamping teeth 33C. Spring 31 holds end 32B of top portion 32 against end 33B of bottom portion 33. Top portion 32 has, proximate to end 32B, clamping teeth 32C that mate with the clamping teeth 33C. Clamping teeth 32C of clip 30 may be disengaged by exerting downward force on end 32A of top portion 32, causing portion 32 to rotate about the axis at spring 31, thereby separating clamping teeth 32C from clamping teeth 33C.

Referring now to FIG. 5, assembly 3000 shows device 200 affixed to drill 50 and shows a mixing tool secured in clamp 30. The mixing tool shown in assembly 3000 is paint stirrer 1, however any mixing tool capable of being secured in clamp 30. Paint stirrer 1 is inserted into clip 30 at ends 32B and 33B. Paint stirrer 1 is held firmly in clip 30 by virtue of clamping teeth 32C and 33C. The force exerted by spring 31 urges top portion 32 of clip 30 down onto stirrer 1. Clamping teeth 33C further aid in securing stirrer 1 in clamp 30. End 10A of shaft 10 of device 200 is inserted into drill 50 at chuck 51 of drill 50. Chuck 51 of drill 50 expands and contracts to receive drill bits, as is known in the art, and is expanded to receive shaft 10 and then contracted to secure shaft 10 in chuck 51 of drill 50. Paint stirrer 1 of assembly 3000 can be inserted into a container having a quantity of paint. Drill 50 can then be powered to cause shaft 10, and thus paint stirrer 1, to rotate. The rotation of paint stirrer 1 causes the paint to mix.

Drill 50 may be purchased separately from device 200 or, in some embodiments, may be sold as part of a paint stirring kit including drill 50 and device 200. The paint stirring kit may further comprise paint stirrers, and the included paint stirrers may be disposable. Device 200 may be sold as an individual device or may be offered for sale with paint stirrers. In some embodiments, containers may be provided in which paint can be poured and then mixed and/or poured into and stored after mixing.

Referring now to FIG. 6, another embodiment 300 of a mixing device is disclosed. Device 300 has shaft 20 having first end 20A and second end 20B. Clamp 60 is fixed to shaft 20 at end 20B. Clamp 60 has clamp end 60A and shaft end 60B. Clamp 60 further includes receiving slot 62 and threaded through hole 61. Receiving slot 62 is configured to receive a mixing tool. Receiving slot 62 may, in some embodiments, have a height slightly larger than the thickness of paint stirrer 1. Slot 62 may include one or more features on one or more of its internal surfaces that aid in securing a mixing too within the slot. For example and shown in FIG. 6, slot 62 has teeth 63 on the slot surface opposite fastener 70. Fastener 70 having threads that mate with the threads in hole 61 passes through hole 61 into receiving slot 62. When a mixing tool is inserted into slot 62, the force exerted by fastener 70, coupled with teeth 63, ensure that the tool is securely fixed in slot 62.

Turning now to FIG. 7 and referring to assembly 3000, device 300 can be affixed to drill 50 and receive a mixing tool at end 60A of clamp 60. The mixing tool shown in FIG. 7 is paint stirrer 1, however the mixing tool may be any mixing tool capable of being secured in receiving slot 62 by fastener 70. As shown in FIG. 7, paint stirrer 1 is inserted into receiving slot 62 and fastener 70 is threaded through hole 61 such that it passes through hole 61 into receiving slot 62 and exerts force on paint stirrer 1. The force exerted on paint stirrer 1 by fastener 70 holds paint stirrer 1 securely in receiving slot 62.

End 20A of shaft 20 of device 300 is inserted into drill 50 at chuck 51 of drill 50. Chuck 51 of drill 50 expands and contracts to receive drill bits, as is known in the art, and is expanded to receive shaft 20 and then contracted to secure shaft 20 in chuck 51 of drill 50. Paint stirrer 1 of assembly 3000 can then be inserted into a container having a quantity of paint. Drill 50 can then be powered to cause shaft 20, and thus paint stirrer 1, to rotate. The rotation of paint stirrer 1 causes the paint to mix. Device 300 may be sold alone or in a kit. The kit may include any of paint stirrers, mixing/storage containers and drill 50.

After any of devices 100, 200, or 300 are used to mix paint, stirrer 1 can be removed from the device and discarded. This advantageously avoids having to clean the disclosed devices after they are used. Alternatively, and for example if the stirrer is of a material other than inexpensive wood, the stirrer can be removed and cleaned for subsequent use. The ability to remove the stirrer from the device facilitates any cleaning of the stirrer a user may perform.

Though the disclosed devices, assemblies, and methods are capable of mixing paint, the disclosed devices, assemblies, and methods may be used to mix other materials. For example, the disclosed devices and assemblies may be used to mix cement, concrete, epoxy, resins, and any other material that requires or benefits from being mixed.

Although certain representative embodiments and advantages have been described in detail, it will be apparent to those skilled in the art that various modifications and variations can be made in the present disclosure without departing from the scope or spirit of the disclosure. Other embodiments of the disclosure will be apparent to those skilled in the art from consideration of the specification and practice of the devices, assemblies, and methods disclosed herein. It is intended that the specification and examples be considered as exemplary only.

What is claimed is:

1. A paint stirring device comprising:
a shaft having a first end and a second end; and
a clamp affixed the second end of the shaft, wherein the clamp is configured to receive a mixing tool.

2. The device of claim 1, wherein the mixing tool is a paint stirrer.

3. The device of claim 3, wherein the mixing tool is disposable.

4. The device of claim 1, wherein the shaft and at least a portion of the clamp are a single continuous body.

5. The device of claim 3, wherein the clamp comprises a receiving slot configured to receive a paint stirrer.

6. The device of claim 2, wherein the clamp further comprises a fastener that passes through at least a portion of the clamp and into the receiving slot.

7. The device of claim 3, wherein the fastener is capable of securing a paint stirrer in the receiving slot.

8. The device of claim 1, wherein the clamp comprises a bottom portion and a top portion, the bottom portion and top portion each having a first end and a second end, and wherein the bottom portion and top portion are connected to one another by a spring that enables the top portion to rotate about the axis of the spring.

9. The device of claim 5, wherein the spring urges the first end of the top portion into contact with the first end of the bottom portion.

10. The device of claim 6, wherein the first end of the bottom portion has a set of bottom teeth and the first end of the top portion has a set of top teeth, and the top teeth and bottom teeth mate with one another when the top portion is urged into contact with the bottom portion.

11. The device of claim 7, wherein the top teeth are configured to disengage with the bottom teeth when a downward force is exerted onto the second end of the top portion.

12. The device of claim 8, wherein a paint stirrer can be inserted in between the bottom teeth and top teeth.

13. The device of claim 1, wherein the first end of the shaft is sized to be received by one of a power drill or an electric screwdriver.

14. The device of claim 6, wherein the first end of the shaft is sized to be received by one of a power drill or an electric screwdriver.

15. The device of claim 11, wherein the first end of the shaft is sized to be received by one of a power drill or an electric screwdriver.

16. A paint stirring kit, the kit comprising:
paint stirring device having a shaft having a first end and a second end and a clamp affixed the second end of the shaft, wherein the clamp is configured to receive a paint stirrer; and
a plurality of disposable paint stirrers.

17. The kit of claim 15, wherein the clamp of the paint stirring device comprises a bottom portion having a set of bottom teeth and a top portion having a set of top teeth, wherein the bottom teeth and the top teeth mate with one another.

18. The kit of claim 16, further comprising at least one container having a bottom and at least one side wall having a bottom end connected to the bottom and a top end, and a lid that forms an air-tight seal with the top end of the at least one side wall.

19. The kit of claim 15, further comprising an electric screwdriver.

20. A method of mixing paint, the method comprising:
securing a paint stirrer in the clamp of the device of claim 1;
securing the second end of the shaft in a chuck of an electric screwdriver;
inserting the secured paint stirrer into a quantity of paint to be mixed; and
operating the electric screwdriver to cause the shaft to rotate at a speed of between about 200 RPMs to 3000 RPMs.
